(19) United States
(12) Patent Application Publication
(10) Pub. No.: US 2014/0347611 A1
(43) Pub. Date: Nov. 27, 2014

(54) LIQUID CRYSTAL DISPLAY AND METHOD FOR MANUFACTURING THE SAME

(71) Applicant: Samsung Display Co., Ltd., Yongin-City (KR)

(72) Inventors: Yong Seok Kim, Seoul (KR); Woo Jae Lee, Yongin-si (KR)

(73) Assignee: Samsung Display Co., Ltd., Yongin-City (KR)

(21) Appl. No.: 14/060,086

(22) Filed: Oct. 22, 2013

(30) Foreign Application Priority Data
May 24, 2013 (KR) 10-2013-0059278

(51) Int. Cl. G02F 1/1335

(52) U.S. Cl. CPC G02F 1/133514
USPC 349/106; 445/24

(57) ABSTRACT

A display device includes a substrate; a pixel electrode disposed on the substrate; a roof layer facing the pixel electrode and including a color filter; and a microcavity disposed between the pixel electrode and the roof layer. The microcavity includes a controllable material disposed therein. The color filter includes a first color filter and a second color filter. A first blocking region is disposed on the first color filter and a second blocking region is disposed on the second color filter. The respective thicknesses of the first blocking region and the second blocking region are different.

### CROSS-REFERENCE TO RELATED APPLICATION

This application claims priority from and the benefit of Korean Patent Application No. 10-2013-0059278, filed on May 24, 2013, which is incorporated by reference for all purposes as if set forth herein.

### BACKGROUND

1. Field

Exemplary embodiments relate to display technology, and more particular, to a liquid crystal display and a method for manufacturing the same.

2. Discussion

Conventional liquid crystal displays typically include two display panels including electric field generating electrodes, such as a pixel electrode and a common electrode, and a liquid crystal layer disposed between the two display panels. It is noted that an electric field may be imposed on the liquid crystal layer by applying voltages to the field generating electrodes. In this manner, the electric field may be utilized to control the alignment of liquid crystal molecules of the liquid crystal layer, and, thereby, the polarization of incident light propagating through the liquid crystal layer.

A nano crystal display (NCD) is a type of liquid crystal display manufactured by forming a sacrificial layer on a substrate and forming a roof layer on the sacrificial layer. The sacrificial layer is then removed to form microcavities between the roof layer and the substrate. The microcavities are then filled with liquid crystal molecules once the sacrificial layer is removed. In this manner, the field generating electrodes and the microcavities including the liquid crystal molecules may be disposed on the same substrate. As such, a second substrate may not be utilized, thereby, enabling a NCD liquid crystal display to be thinner than a conventional liquid crystal display.

The above information disclosed in this Background section is only for enhancement of understanding of the background of the invention, and, therefore, it may contain information that does not form the prior art that is already known in this country to a person of ordinary skill in the art.

### SUMMARY

Exemplary embodiments provide a liquid crystal display configured to substitute a roof layer with one or more color filters.

Exemplary embodiments provide a method of manufacturing a liquid crystal display configured to substitute a roof layer with one or more color filiters.

Additional aspects will be set forth in the detailed description which follows and, in part, will be apparent from the disclosure, or may be learned by practice of the invention.

According to exemplary embodiments, a display device includes: a substrate; a pixel electrode disposed on the substrate; a roof layer facing the pixel electrode and including a color filter; and a microcavity disposed between the pixel electrode and the roof layer. The microcavity includes a controllable material disposed therein. The color filter includes a first color filter and a second color filter. A first blocking region is disposed on the first color filter and a second blocking region is disposed on the second color filter. The respective thicknesses of the first blocking region and the second blocking region are different.

According to exemplary embodiments, a method of manufacturing a display device, includes: forming a pixel electrode on a substrate; forming a patterned sacrificial layer on the pixel electrode; forming a roof layer including a color filter on the patterned sacrificial layer; removing the patterned sacrificial layer to form at least one microcavity between the roof layer and the pixel electrode; and disposing a controllable material in the at least one microcavity. Formation of the roof layer includes: forming a first color filter on a first portion of the patterned sacrificial layer, forming a first blocking layer on the patterned sacrificial layer to cover the first color filter, forming a second color filter on a second portion of the patterned sacrificial layer, and forming a second blocking layer on the patterned sacrificial layer to cover the first color filter and the second color filter. A first blocking region is formed on the first color filter and a second blocking region is formed on the second color filter. The respective thicknesses of the first blocking region and the second blocking region are different.

According to exemplary embodiments, a roof layer is substituted with one or more color filters to decrease the number of masks utilized to form an associated liquid crystal display. A blocking layer is formed during a process of forming neighboring color filters to prevent (or otherwise reduce) the potential for neighboring color filters reacting to each other.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a plan view of a liquid crystal display, according to exemplary embodiments.

FIG. 2 is a cross-sectional view of the liquid crystal display of FIG. 1 taken along sectional line II-II, according to exemplary embodiments.

FIG. 3 is a cross-sectional view of the liquid crystal display of FIG. 1 taken along sectional line III-III, according to exemplary embodiments.

FIG. 4 is a perspective view of a microcavity of the liquid crystal display of FIG. 1, according to exemplary embodiments.

FIG. 5 is a cross-sectional view of a liquid crystal display, according to exemplary embodiments.

FIG. 6 is a cross-sectional view of a liquid crystal display, according to exemplary embodiments.

FIGS. 7 to 14 are respective cross-sectional views of the liquid crystal display of FIG. 1 at various stages of manufacture, according to exemplary embodiments.

FIGS. 15 to 21 are respective cross-sectional views of the liquid crystal display of FIG. 5 at various stages of manufacture, according to exemplary embodiments.

FIGS. 22 to 28 are respective cross-sectional views of the liquid crystal display of FIG. 6 at various stages of manufacture, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

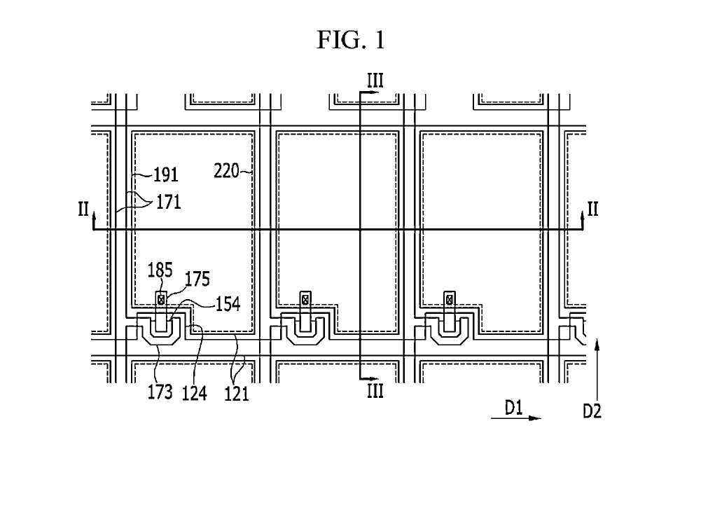

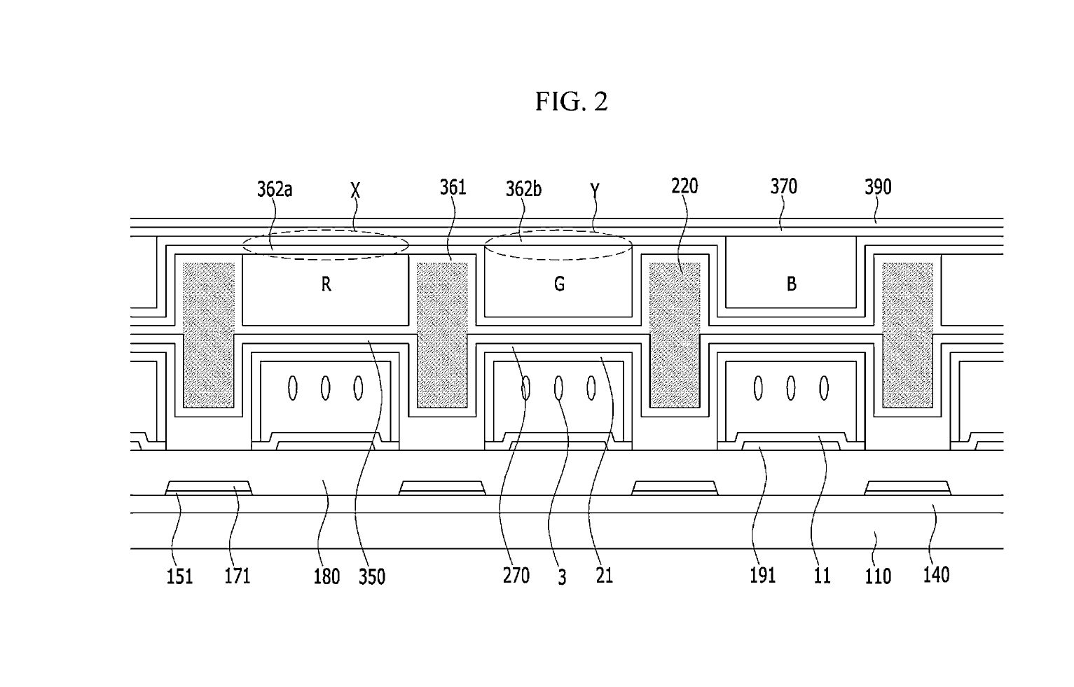

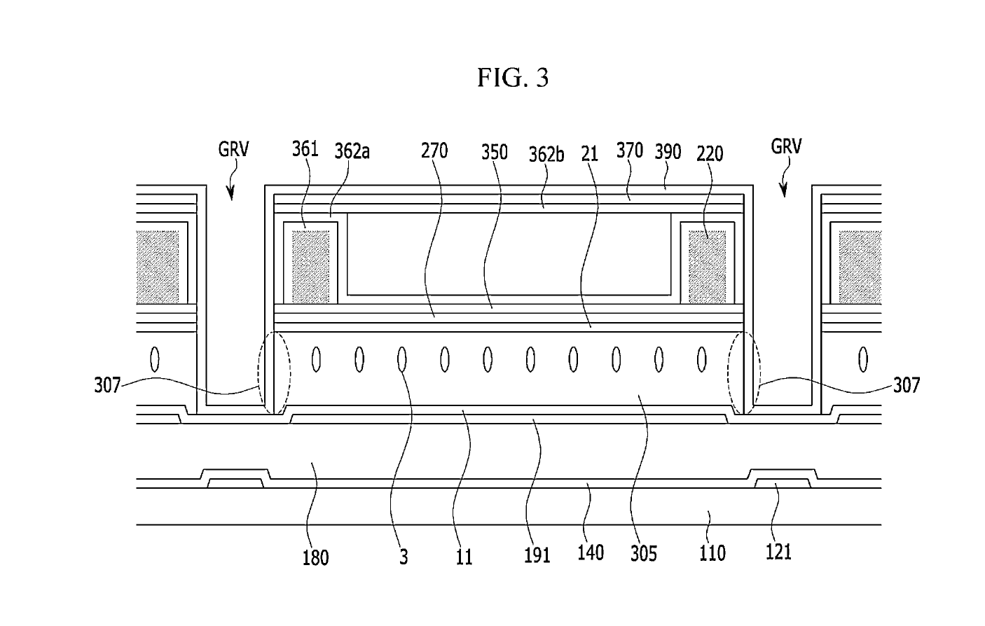

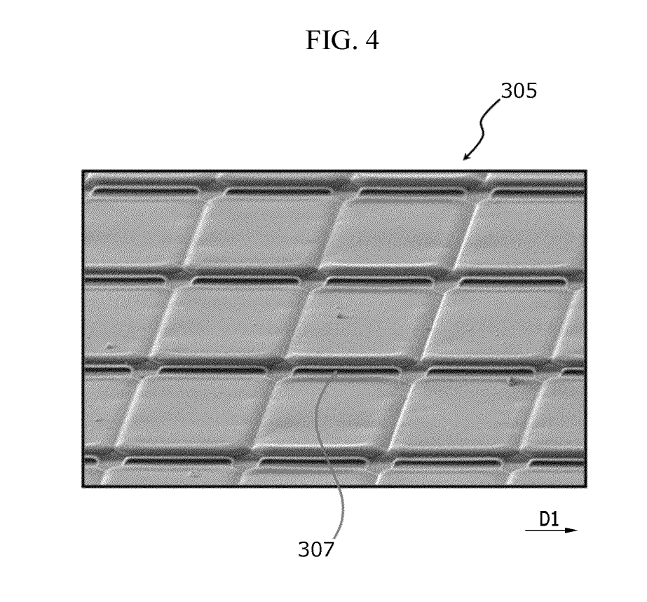

FIG. 1 is a plan view of a liquid crystal display, according to exemplary embodiments. FIG. 2 is a cross-sectional view of the liquid crystal display of FIG. 1 taken along sectional line II-II. FIG. 3 is a cross-sectional view of the liquid crystal display of FIG. 1 taken along sectional line III-III. FIG. 4 is a perspective view of a microcavity of the liquid crystal display of FIG. 1, according to exemplary embodiments.

Referring to FIGS. 1 to 3, a plurality of gate lines 121 is formed on a substrate 110 made of transparent glass or plastic.

The gate lines 121 transfer gate signals and longitudinally extend primarily a first direction D1 (e.g., a horizontal or row direction). Each gate line 121 includes a plurality of gate electrodes 124. The gate electrodes 124 protrude from the gate line 121.

The gate lines 121 and the gate electrodes 124 may be made of any suitable material, such as, for instance, aluminum (Al), an aluminum alloy, silver (Ag), a silver alloy, copper (Cu), a copper alloy, etc.

In exemplary embodiments, the gate lines 121 and the gate electrodes 124 are formed by a single layer, but are not limited thereto and may be formed in a dual-layer, triple-layer, etc., structure.

When the gate lines 121 and the gate electrodes 124 have a dual-layer structure, the gate lines 121 and the gate electrodes 124 may be formed by a lower layer and an upper layer. The lower layer may be formed of any suitable material, such as, for example, molybdenum (Mo), a molybdenum alloy, chrome (Cr), a chrome alloy, titanium (Ti), a titanium alloy, tantalum (Ta), a tantalum alloy, manganese (Mn), a manganese alloy, etc. The upper layer may be made of any suitable material, such as, for example, aluminum, (Al), an aluminum alloy, silver (Ag), a silver alloy, copper (Cu), a copper alloy, etc. When a triple-layer structure is utilized, layers of different physical properties may be combined to form the multilayer structure.

A gate insulating layer 140 is formed on the gate line 121.

Semiconductor layers 151 are formed on the gate insulating layer 140. The semiconductor layers 151 longitudinally extend primarily in a section direction D2 (e.g., a vertical or column direction) and include a plurality of projections 154. The projections 154 longitudinally extend toward the gate electrode 124, e.g., longitudinally extend in the first direction D1.

Data lines 171 and drain electrodes 175 are formed on the semiconductor layers 151 in connection with a source electrode 173, respectively.

The data lines 171 transfer data signals and longitudinally extend primarily in the second direction D2 to cross the gate lines 121. The respective data lines 171 are connected with the plurality of source electrodes 173 that extend toward corresponding gate electrodes 124 and have a U shape.

Respective drain electrodes 175 are separated from corresponding data lines 171 and extend upward at the center of the U shape of a corresponding source electrode 173. The shapes of the source electrodes 173 and the drain electrodes 175 are merely illustrative and may be provided in any suitable shaped and/or configuration.

Data wiring layers 171, 173, and 175 including the data line 171, the source electrode 173, and the drain electrode 175 may be made of any suitable material, such as, for instance, aluminum (Al), an aluminum alloy, silver (Ag), a silver alloy, copper (Cu), a copper alloy, etc., or combinations thereof.

In exemplary embodiments, a corresponding data line 171, source electrode 173, and drain electrode 175 are formed of a single layer, but any other suitable configuration may be utilized. For instance, one or more of the data line 171, the source electrode 173, and the drain electrode 175 may be formed of dual-layers, triple-layers, etc.

When the data line 171, the source electrode 173, and the drain electrode 175 have a dual-layer structure, the data line 171, the source electrode 173, and the drain electrode 175 may be formed with a lower layer and an upper layer. The lower layer may be formed of any suitable material, such as, for instance, molybdenum (Mo), a molybdenum alloy, chrome (Cr), a chrome alloy, titanium (Ti), a titanium alloy, tantalum (Ta), a tantalum alloy, manganese (Mn), a manganese alloy, etc., or combinations thereof. The upper layer may be made of any suitable material, such as, for example, aluminum (Al), an aluminum alloy, silver (Ag), a silver alloy, copper (Cu), a copper alloy, etc., or combinations thereof. When the triple-layer structure is utilized, the various layers may have different physical properties.

The projection 154 of the semiconductor layer 151 includes an exposed portion that is not covered by the data line 171 and the drain electrode 175. The exposed portion is disposed between the source electrode 173 and the drain electrode 175. The projection 154 of the semiconductor layer has substantially the same plane pattern as the data line 171, the source electrode 173, and the drain electrode 175, except for the exposed portion of the projection 154. In other words, side walls of the data line 171, the source electrode 173, and the drain electrode 175 may be arranged substantially similarly with side walls of the semiconductor layer 151, which are disposed therebelow. In this manner, the data wiring layers 171, 173, and 175 including the data line 171, the source electrode 173, and the drain electrode 175, and the semiconductor layer 151 may be formed using the same mask.

According to exemplary embodiments, a gate electrode 124, a source electrode 173, and a drain electrode 175 may form a thin film transistor (TFT) together with a projection 154 of a semiconductor layer 151. A channel of the thin film transistor is formed on the projection 154 between the source electrode 173 and the drain electrode 175.

A passivation layer 180 is disposed on the data line 171, the drain electrode 175, and the exposed portion of the projection 154 of the semiconductor layer. The passivation layer 180 may be made of any suitable material, such as, for example, an inorganic insulator (e.g., silicon nitride, silicon oxide, etc.), an organic insulator, a low-dielectric insulator, etc.

A plurality of pixel electrodes 191 is disposed on the passivation layer 180. The pixel electrode 191 is physically and electrically connected with the drain electrode 175 through a contact hole 185 that penetrates the passivation layer 180 and is applied with data voltage from the drain electrode 175. The pixel electrode 191 may be made of any suitable transparent conductor, such as, for instance, aluminum zinc oxide (AZO), gallium zinc oxide (GZO), indium tin oxide (ITO), indium zinc oxide (IZO), etc., or combinations thereof. It is also contemplated that one or more conductive polymers (ICP) may be utilized, such as, for example, polyaniline, poly(3,4-ethylenedioxythiophene) poly(styrenesulfonate) (PEDOT:PSS), etc.

Although not illustrated, the pixel electrode 191 may include a plurality of small electrodes or micro slit electrodes.

A lower alignment layer 11 is formed on the pixel electrode 191 and may be a vertical alignment layer. The lower alignment layer 11 may function as a liquid crystal alignment layer, and may be formed from any suitable material, e.g., polyamic acid, polysiloxane, polyimide, etc., and/or combinations thereof.

A microcavity 305 is disposed on the lower alignment layer 11. A liquid crystal material containing a liquid crystal molecule 3 is injected into the microcavity 305. The microcavity 305 has a liquid crystal injection hole 307. The microcavity 305 may be formed to extend in the second direction D2 in correspondence with the pixel electrode 191. In exemplary embodiments, the liquid crystal material may be injected into the microcavity 305 using capillary force.

Referring to FIGS. 3 and 4, the microcavity 305 includes a plurality of regions divided by a plurality of grooves GRV disposed at portions which overlap with the gate lines 121. The groove GRV may extend in the first direction D1 in which the gate lines 121 extend. The plurality of regions of the microcavity 305 may correspond to respective pixel regions and may be spaced apart from one another in the first and second directions D1 and D2.

The liquid crystal injection hole 307 is disposed between the lower alignment layer 11 and an upper alignment layer 21. The liquid crystal injection hole 307 may extend in corresponding directions in which the groove GRV extends. In other words, as seen in FIGS. 3 and 4, the liquid crystal injection hole 307 is formed to longitudinally extend in the first direction D1 in which the gate lines 121 extend.

Although grooves GRV are illustrated as extending in the first direction D1 in which the gate lines 121 extend, it is also contemplated that the grooves GRV may extend in the second direction D2 in which the data lines 171 extend. In this manner, the plurality of regions of the microcavity 305 may extend in the second direction D2, and the liquid crystal injection hole 307 may also be formed to extend in the second direction D2 in which the data lines 171 extend.

The upper alignment layer 21 is disposed on the microcavity 305. A common electrode 270 and a lower insulating layer 350 are disposed on the upper alignment layer 21. The lower insulating layer 350 may be disposed on the common electrode 270. The common electrode 270 may be applied with common voltage, and may be configured to generate an electric field with the pixel electrodes 191 that may be applied with one or more data voltages to control a direction in which liquid crystal molecules 3 disposed in the microcavity 305 are angled. The common electrode 270 forms a capacitor with the pixel electrode 191 to store applied voltage even after a thin film transistor is “turned off.” The lower insulating layer 350 may be made of may suitable material, such as, for example, silicon nitride (SiNx), silicon oxide (SiOx), etc., or combinations thereof.

Although the common electrode 270 is shown formed above the microcavity 305, it is contemplated that the common electrode 270 may be formed below or in a lower portion of the microcavity 305. As such, the common electrode 270 may still enable control of the liquid crystal molecules 3, but may be configured in association with a “horizontal” electric field mode driving scheme of the display device.

As illustrated in FIG. 2, the microcavity 305 may be divided into a plurality of regions spaced apart from one another in the first direction D1. The microcavity 305 may be at least partially surrounded by the common electrode 270 and the lower insulating layer 350. A light blocking member 220 may be disposed between the plurality of microcavities 305 that are disposed adjacent to each other in the first direction D1. The light blocking member 220 may also be referred to as a “black matrix,” and, thereby, may be configured to block light leakage. In exemplary embodiments, the light blocking member 220 includes a portion that extends in the direction in which the data lines 171 extend (e.g., in the second direction D2) and a portion that extends in the direction in which the gate lines 121 extend (e.g., the first direction D1). Further, the light blocking member 220 may be substantially disposed in association with “non-display” areas of the display device, e.g., portions other than “display areas” where pixels display images.

An inorganic layer 361 may cover the light blocking member 220 and may be disposed on the lower insulating layer 350. It is contemplated, however, that the inorganic layer 361 may be omitted.

According to exemplary embodiments, color filters R, G, and B are disposed on the inorganic layer 361. In exemplary embodiments, the color filters R, G, and B function as a “roof” layer, and may also function to protect the microcavity 305 from external pressure and/or other ambient conditions/forces/contaminants. The color filters R, G, and B may extend in the second direction D2, e.g., in the direction of extension of pixel electrodes 191. Each color filter R, G, or B may be configured to express a primary color, such as, a red, green, or blue color. For instance, adjacent color filters R, G, and B may be configured to express different colors from one another. It is contemplated, however, that any other (or additional) suitable color may be utilized, such as, for instance, cyan, magenta, yellow, white, etc., colors.

A projected portion of the light blocking member 220 may function as a partition to partition the color filters R, G, and B that are adjacent to each other. A first blocking layer 362a and a second blocking layer 362b are disposed on a first color filter R. The second blocking layer 362b is disposed on a second color filter G that is adjacent to the first color filter R. The first blocking layer 362a and the second blocking layer 362b that are disposed on the first color filter R form a first blocking region X, and the second blocking layer 362b disposed on the second color filter G forms a second blocking region Y. The first blocking layer 362a and the second blocking layer 362b may be formed of any suitable material, such as, for instance, a transparent inorganic material, e.g., indium tin oxide (ITO), indium zinc oxide (IZO), silicon oxide, silicon nitride, etc., or combinations thereof. The first blocking region X is thicker than the second blocking region Y.

A third color filter B is disposed adjacent to the second color filter G. An upper insulating layer 370 is disposed on the third color filter B. The upper insulating layer 370 may be disposed to extend above the second blocking layer 362b that is disposed on the first color filter R and the second color filter G.

According to exemplary embodiments, the first color filter R may be disposed on the inorganic layer 361, such that the inorganic layer is disposed between the first color filter R and the substrate 110. The second color filter G may be disposed on the first blocking layer 362a and the inorganic layer 361, such that the first blocking layer 362a is disposed between the second color filter G and the substrate 110. The third color filter B may be disposed on the first blocking layer 362a, the second blocking layer 362b, and the inorganic layer 361, such that the first blocking layer 361 and the second blocking layer 362b is disposed between the third color filter B and the substrate 110. In this manner, the respective “upper” surfaces of the first, second, and third color filters R, G, and B may be disposed a correspondingly different heights from the substrate 110. For instance, the upper surface of the first color filter R may be disposed closest to the substrate 110, the upper surface of the third color filter B may be disposed furthest from the substrate 110, and the upper surface of the second color filter G may be disposed between the respective upper surfaces of the first and third color filters R and B. The same may be true for the respect lower surfaces of the first, second, and third color filters R, G, and B.

A capping layer 390 is disposed on the upper insulating layer 370. The capping layer 390 may cover (or otherwise seal) the liquid crystal injection hole 307 of the microcavity 305 exposed by the groove GRV. In exemplary embodiments, the capping layer 390 may be made of any suitable material, such as, for example, a thermosetting resin, silicon oxycarbide (SiOC), grapheme, etc., or combinations thereof.

According to exemplary embodiments, because the liquid crystal material is injected through the liquid crystal injection hole 307 of the microcavity 305, the liquid crystal display may be formed without an additional upper substrate, however, an additional upper substrate may be utilized. When not utilized, however, this may reduce the manufacturing time and costs, as well as the potential for defects of the display device, as well as reduce costs to consumers and increase the duration of the lifecycle of the display device.

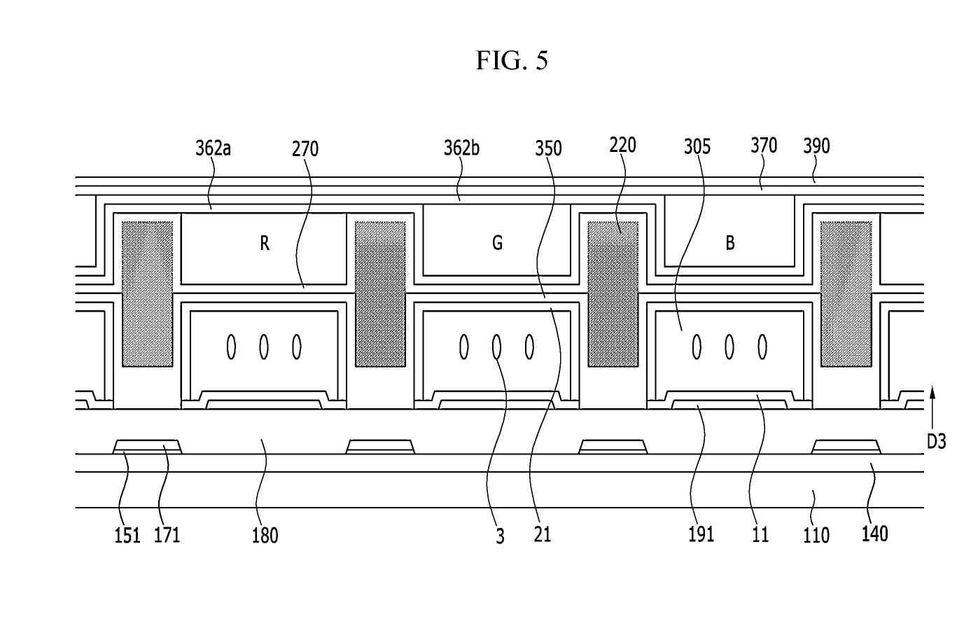

FIG. 5 is a cross-sectional view of a liquid crystal display, according to exemplary embodiments. It is noted that the liquid crystal display of FIG. 5 is substantially similar to the liquid crystal display of FIGS. 2-4. As such, to avoid obscuring exemplary embodiments described herein, primarily differences are provided below.

Referring to FIG. 5, the lower insulating layer 350 is disposed on the upper alignment layer 21. The lower insulating layer 350 may be made of any suitable material, such as, for example, silicon nitride (SiNx), silicon oxide (SiOx), etc., or combinations thereof. The microcavity 305 is a structure that is at least partially surrounded by the lower insulating layer 350, instead of at least partially surround by the lower insulating layer 350 and the common electrode 270, as illustrated in FIG. 2. This, however, is not to say that the common electrode 270 is not disposed on the microcavity 305.

According to exemplary embodiments, the light blocking member 220 is disposed between the plurality of microcavities 305 that are disposed adjacent to each other in the first direction D1, e.g., in the direction in which the gate lines 121 extend. The light blocking member 220 may include a portion that is projected in the third direction D3 to function as a divider between adjacent microcavities 305 adjacent to one another in the first direction D1. To this end, the light blocking member 220 may be disposed on the lower insulating layer 350.

As seen in FIG. 5, the common electrode 270 is disposed on and covers the light blocking member 220. To this end, the common electrode 270 is disposed on the lower insulating layer 350. As such, the inorganic layer 361 illustrated in FIG. 2 may be omitted, however, it is contemplated that the inorganic layer 361 may be disposed between the color filters R, G, and B and the common electrode 270. In this manner, the inorganic layer 361 may at least function to protect the first color filter R from being contaminated by one or more contaminants migrating from the common electrode 270.

According to exemplary embodiments, because the common electrode 270 is disposed on the projected portion of the light blocking member 220 extending in the third direction D3, a distance from the data line 171 increases in these regions of the common electrode 270. As such, a parasite capacitance between the data voltage applied to the data line 171 and the common voltage applied to the common electrode 270 may decrease, which may increase the display quality of the associated display device.

In exemplary embodiments, the color filters R, G, and B are disposed on the common electrode 270. To this end, the color filters R, G, and B function as a “roof” layer and may also function to protect the microcavity 305 from external pressure and/or other ambient conditions/forces/contaminants.

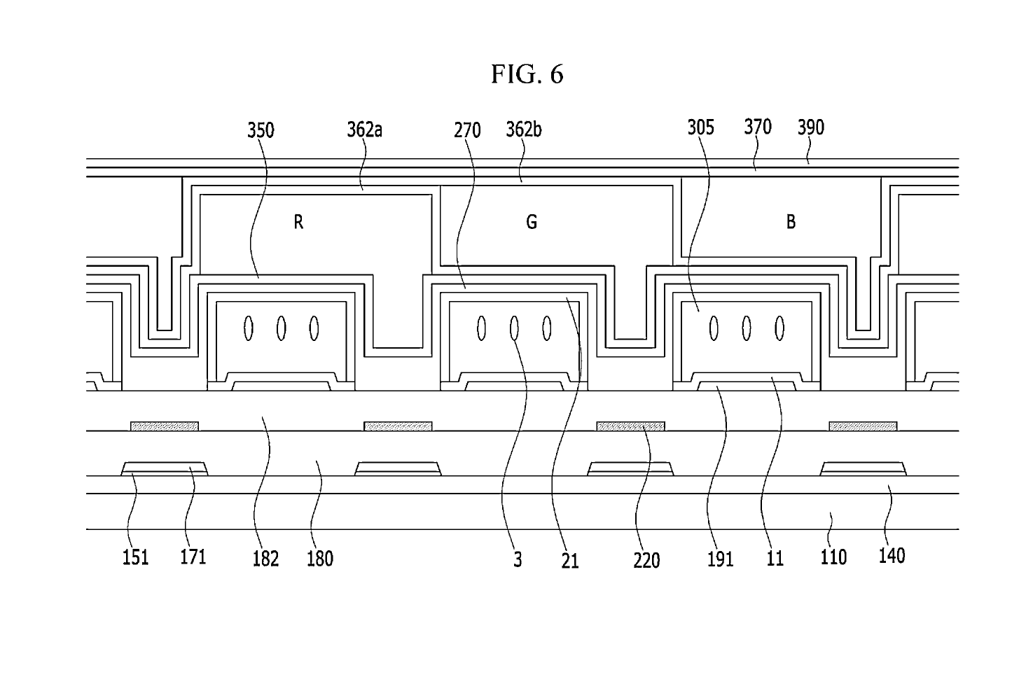

Although the color filters R, G, and B are illustrated in FIGS. 2 and 5 as being substantially contained within a region occupied by the corresponding microcavities 305, it is contemplated that at least respective portions of the color filters R, G, and B may extend into a region disposed between adjacent color filters R, G, and B. An example of such a configuration is described in more detail in association with FIG. 6.

FIG. 6 is a cross-sectional view of a liquid crystal display, according to exemplary embodiments of the present invention. It is noted that the liquid crystal display of FIG. 6 is substantially similar to the liquid crystal displays of FIGS. 2-5. As such, to avoid obscuring exemplary embodiments described herein, primarily differences are provided below.

Referring to FIG. 6, the passivation layer 180 covers a thin film transistor (not illustrated) that is disposed on the substrate 110. The light blocking member 220 is disposed on the passivation layer 180. Unlike as shown in FIGS. 2-4, the light blocking member 220 is disposed below the microcavity 305. That is, the light blocking member 220 is disposed between the microcavity 305 and the substrate 110. To this end, a planarizing layer 182 is disposed on the light blocking member 220. Additionally or alternatively, the passivation layer 180 may be patterned, such that the light blocking member 220 is at least partially recessed in the passivation layer 180. For instance, an upper surface of the light blocking member 220 may be recessed, flush, or extend beyond an upper surface of the passivation layer 180. When the upper surface of the light blocking member 220 is flush (e.g., coplanar) with the upper surface of the passivation layer 180, the planarizing layer 182 may be omitted. In this manner, an overall thickness of the display device extending in the third direction may be decreased.

Although In FIG. 6, the light blocking member 220 is disposed below the pixel electrode 191, it is also contemplated that any other suitable configuration may be utilized. For instance, the light blocking member 220 may be disposed on the pixel electrode 191 and below the microcavity 305, or, in other words, the light blocking member 220 may be disposed between the microcavity 305 and the pixel electrode 191. Further, the light blocking member 220 may be disposed coplanar with the pixel electrode 191. In this manner, the common electrode 270 may be disposed on the light blocking member 220, instead of being disposed on the planarizing layer 182, as shown in FIG. 6. To this end, when the light blocking member 220 is disposed coplanar with the pixel electrode 191, the planarizing layer 182 may be omitted, such that the light blocking member is disposed on the passivation layer 180. In this manner, an overall thickness of the display device extending in the third direction may be decreased.

As seen in FIG. 6, because the light blocking member 220 is disposed below the microcavity 305 (e.g., the light blocking member 220 is disposed between the microcavity and the substrate 110 in the third direction D3), a space between the plurality of microcavities 305 that are adjacent to each other in the first direction D1 may be at least partially occupied by respective portions of the color filters R, G, and B. In this manner, respective portions of the color filters R, G, and B may extend below an upper surface of the respective microcavities 305. In other words, the lower surfaces of the color filters R, G, and B may be disposed closer to the substrate 110 in the third direction D3 than the upper surfaces of the microcavities 305. It is also noted that although the inorganic layer 361 is omitted in FIG. 6, the inorganic layer 361 may be utilized.

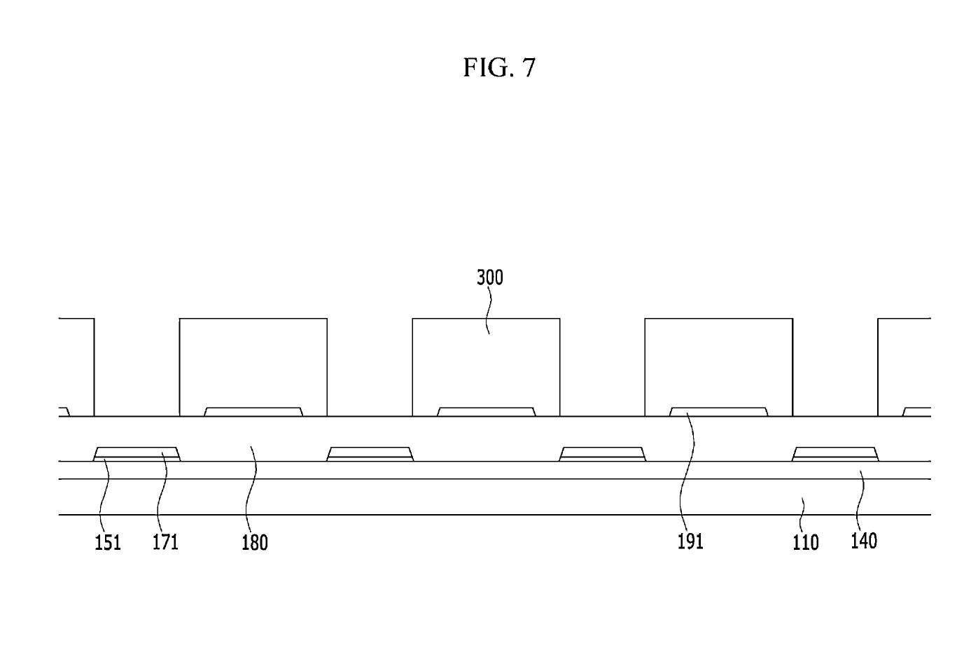

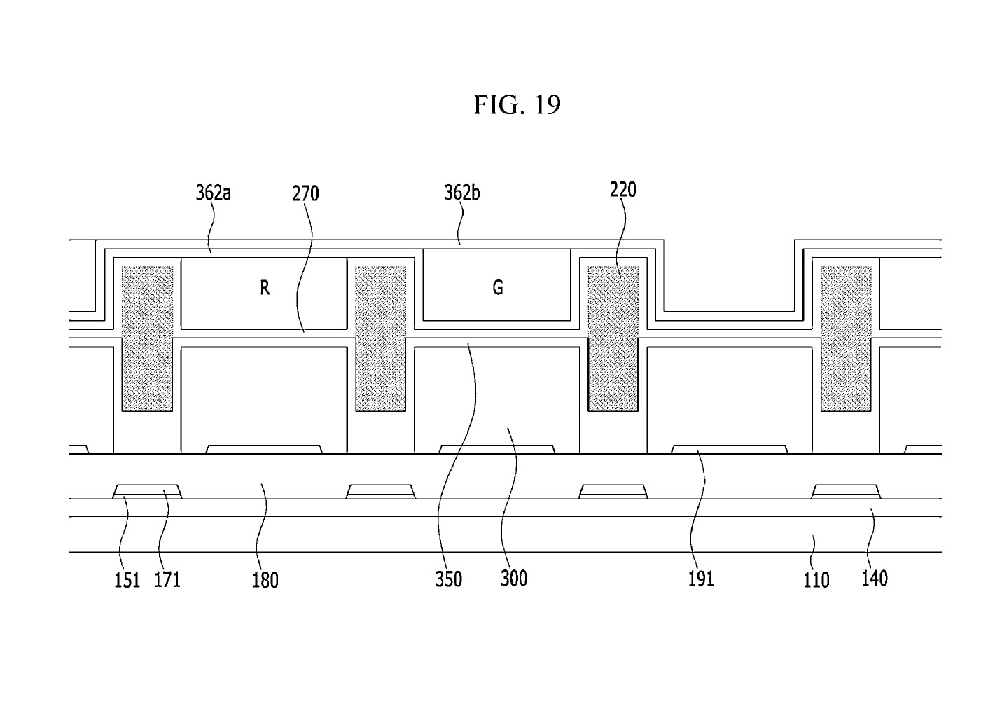

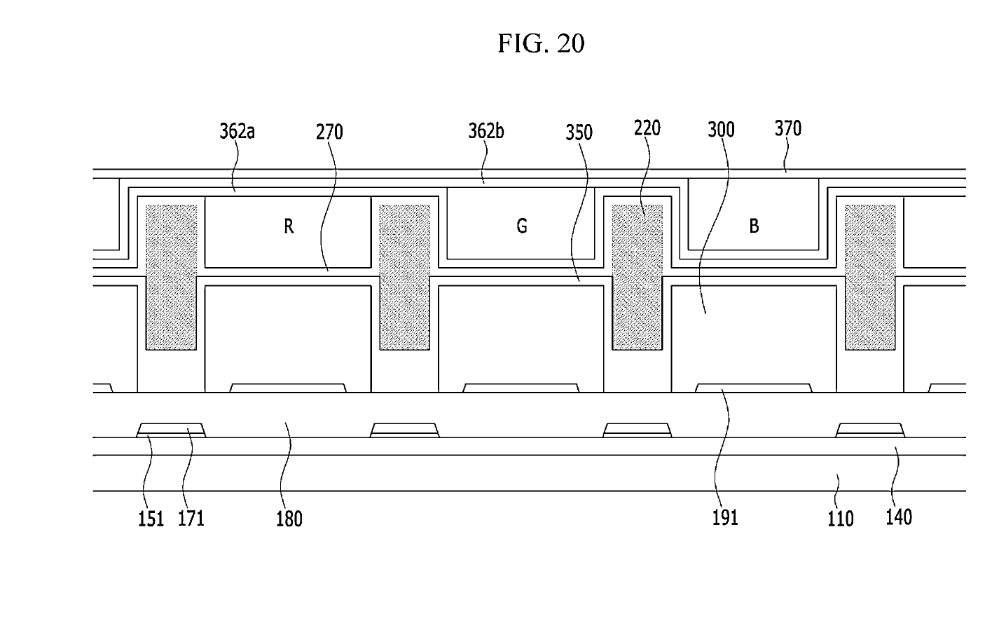

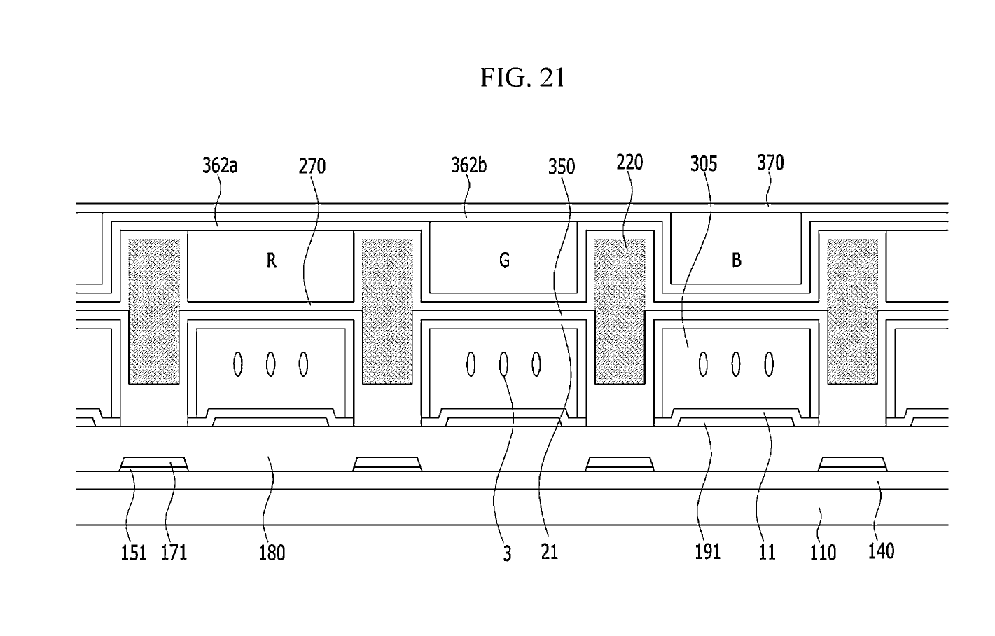

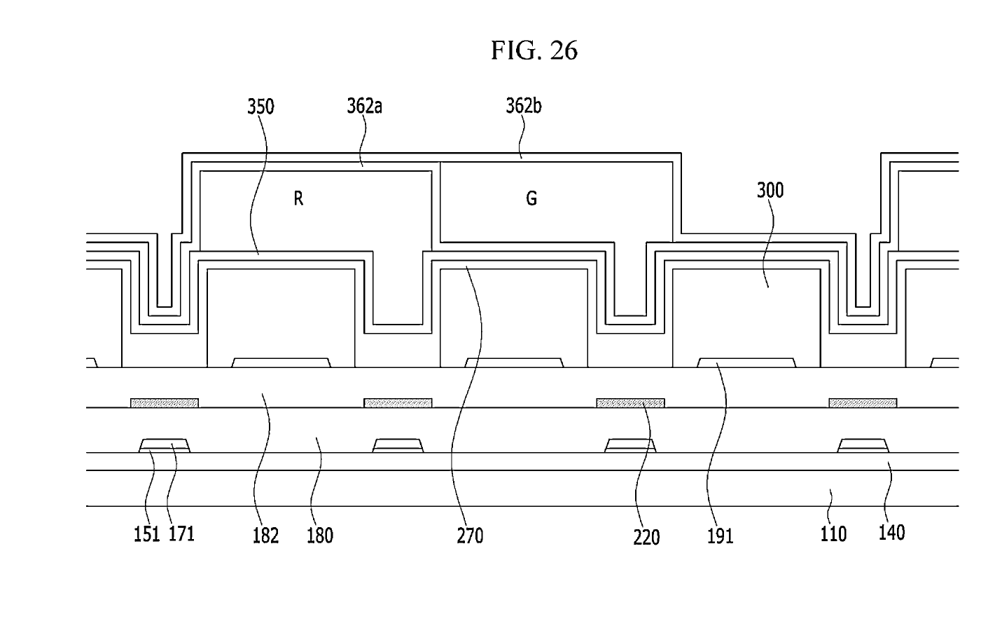

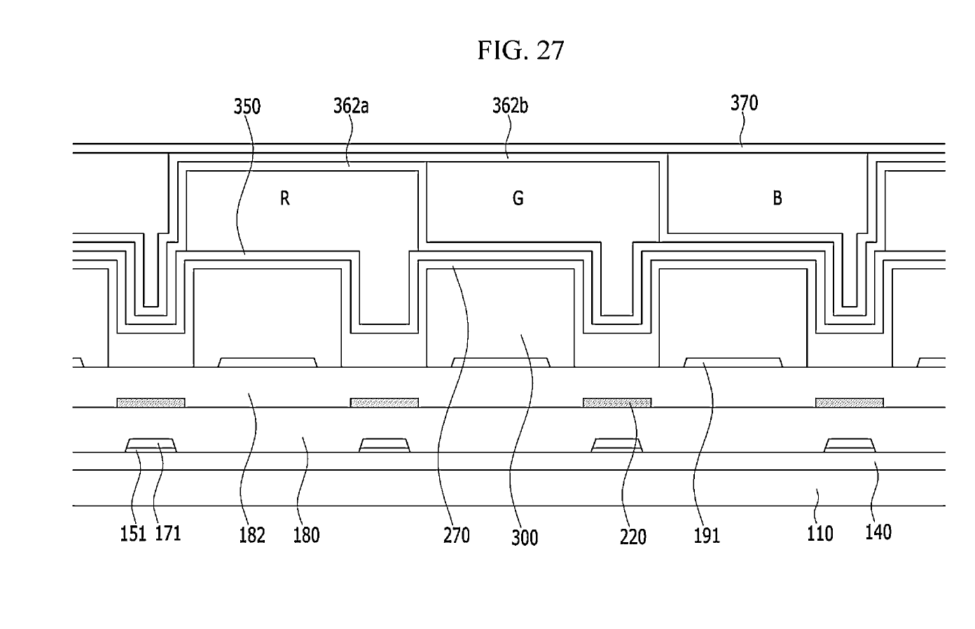

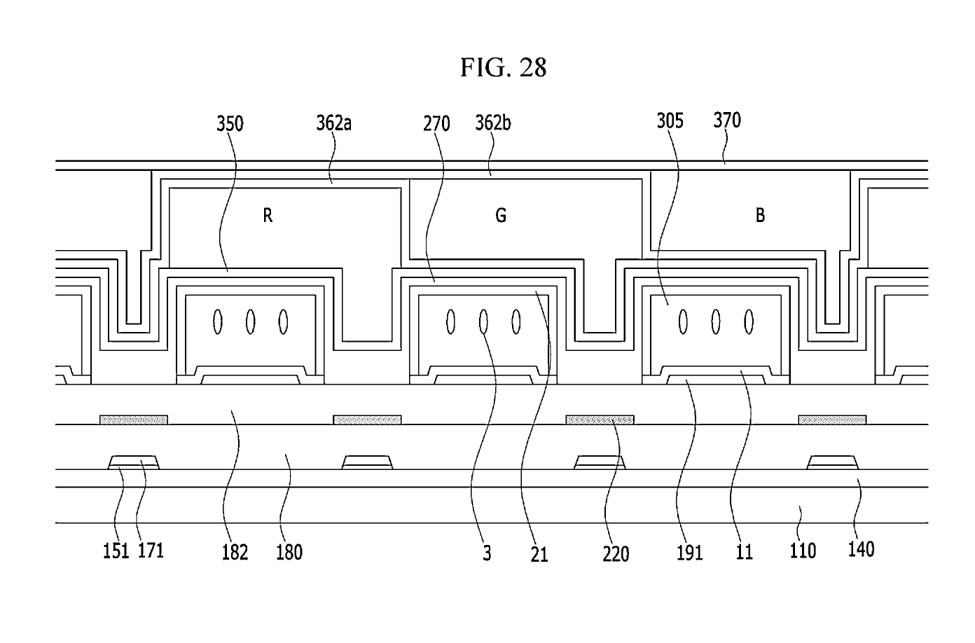

Exemplary manufacturing processes that may be utilized to form the liquid crystal display devices of FIGS. 1-6 will be described in association with FIGS. 7 to 28.

FIGS. 7 to 14 are respective cross-sectional views of the liquid crystal display of FIG. 1 at various stages of manufacture, according to exemplary embodiments.

Referring to FIG. 7, a pixel electrode 191 is formed on the substrate 110, which includes the gate lines 121, the gate insulating layer 140 disposed on the gate lines 121, the semiconductor layers 151 formed on the gate insulating layer 140, the data lines 171 formed on portions of the semiconductor layers 151, and a passivation layer 180 covering the data lines 171 and disposed on the gate insulating layer 140. In other words, the pixel electrode 191 is formed on the passivation layer 180. A sacrificial layer 300 is formed on the pixel electrode 191. The sacrificial layer 300 is patterned to expose portions of the passivation layer 180. The exposed portions of the passivation layer 180 longitudinally extend in the second direction D2. It is noted that the sacrificial layer 300 may be patterned via one or more lithographic and/or developing procedures. In this manner, the sacrificial layer 300 may be divided into portions separated from one another in the first direction D1.

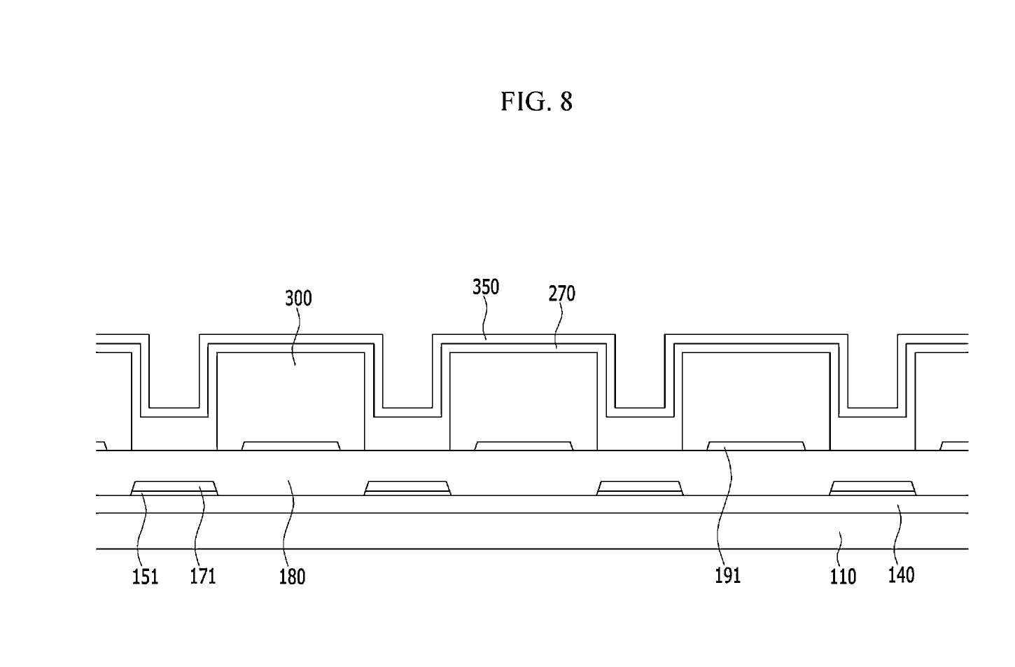

Referring to FIG. 8, the common electrode 270 and the lower insulating layer 350 are sequentially formed to cover the patterned sacrificial layer 300 and the exposed portions of the passivation layer 180. The common electrode 270 may be formed from any suitable material, such as, for instance, a transparent conductive material, e.g., AZO, GZO, ITO, IZO, etc., or combinations thereof. It is also contemplated that one or more ICPs may be utilized. The lower insulating layer 350 may be formed from any suitable material, such as silicon nitride (SiNx), silicon oxide (SiOx), etc., or combinations thereof.

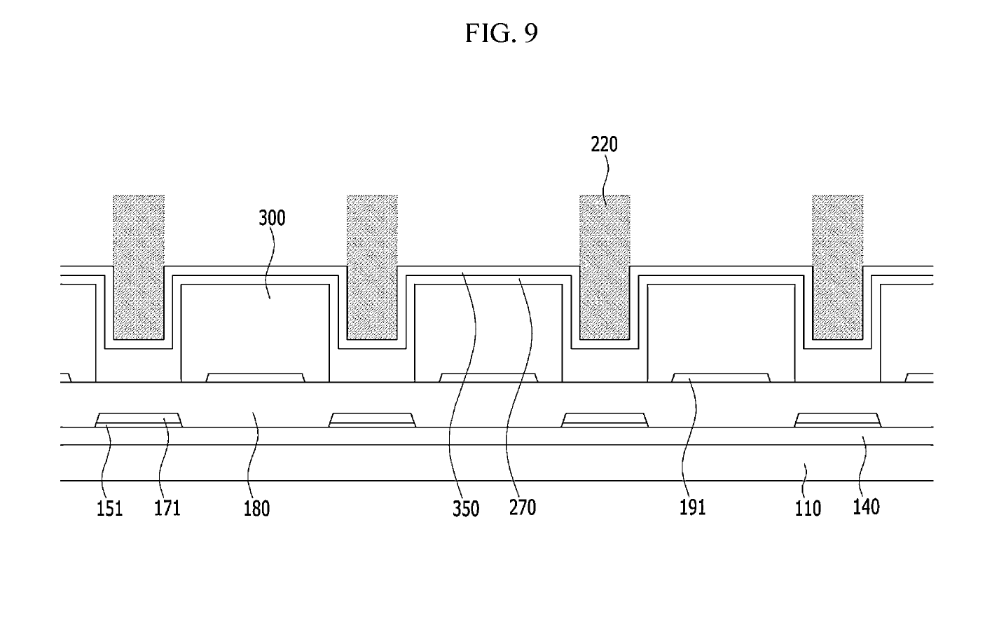

Referring to FIG. 9, the light blocking member 220 is formed between the sacrificial layers 300 that are spaced apart from each other in the first direction D1. In this manner, the light blocking member 220 may be formed including a portion that is projected upward from the lower insulating layer 350 in the third direction D3. As such, an upper surface of the light blocking member 220 may project beyond an upper surface of the lower insulating layer 350.

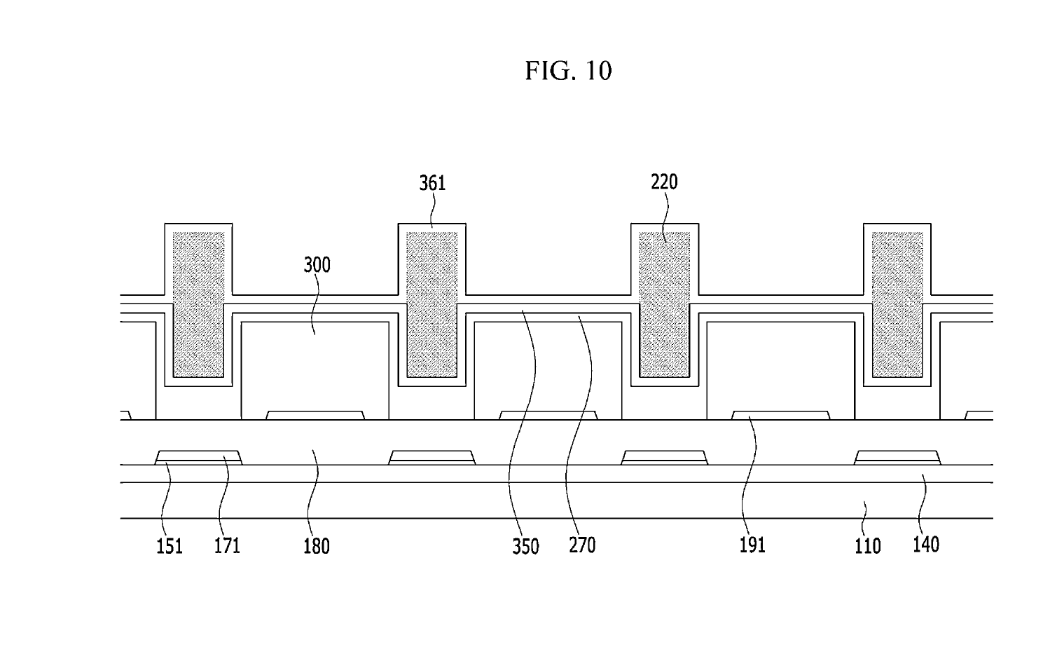

Referring to FIG. 10, the inorganic layer 361 is formed on the lower insulating layer 350 and covers the projected portions of the light blocking member 220. The inorganic layer 361 may function to protect the light blocking member 220. It is noted, however, that the inorganic layer 361 may be omitted.

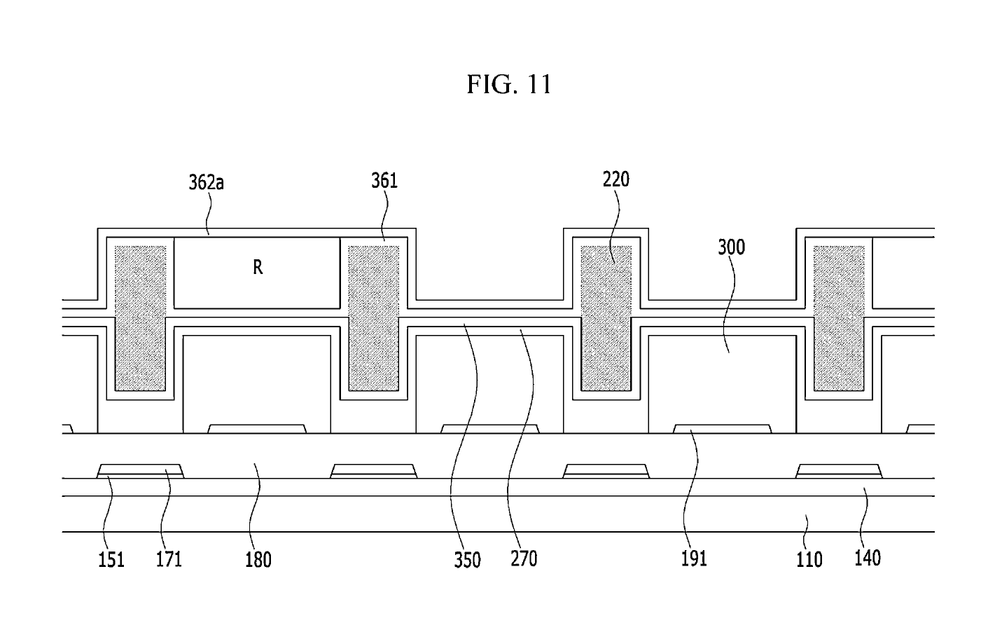

Referring to FIG. 11, the first color filter R is formed between the projected portions of the light blocking member 220 disposed in association with a first sacrificial pattern SP1. Thereafter, the first blocking layer 362a is formed on the inorganic layer 361 and covers the first color filter R. The first blocking layer 362a may be formed form any suitable material, such as, for example, a transparent inorganic material, e.g., AZO, GZO, ITO, IZO, silicon oxide, silicon nitride, or the like, or combinations thereof.

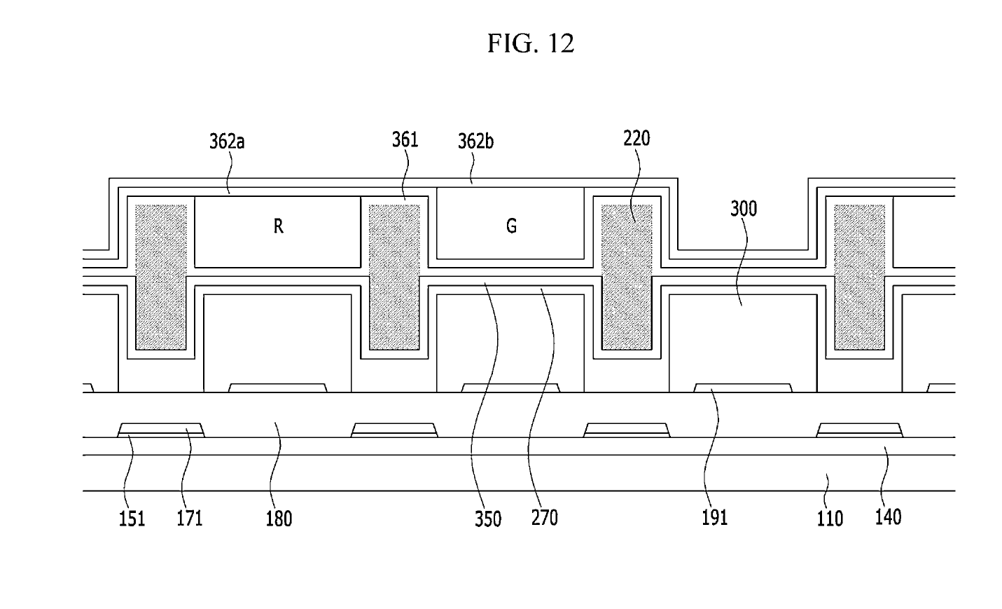

Referring to FIG. 12, the second color filter G is formed between the projected portions of the light blocking member 220 disposed in association with a second sacrificial pattern SP2. The second sacrificial pattern SP2 is disposed adjacent to the first sacrificial pattern SP1. The second color filter G is formed on the first blocking layer 362a and the second sacrificial pattern SP2. Thereafter, the second blocking layer 362b is formed on the first blocking layer 362a and covers the second color filter G and the first color filter R. The second blocking layer 362b may be formed form any suitable material, such as, for example, a transparent inorganic material, e.g., ITO, IZO, AZO, GZO, silicon oxide, silicon nitride, etc., or combinations thereof.

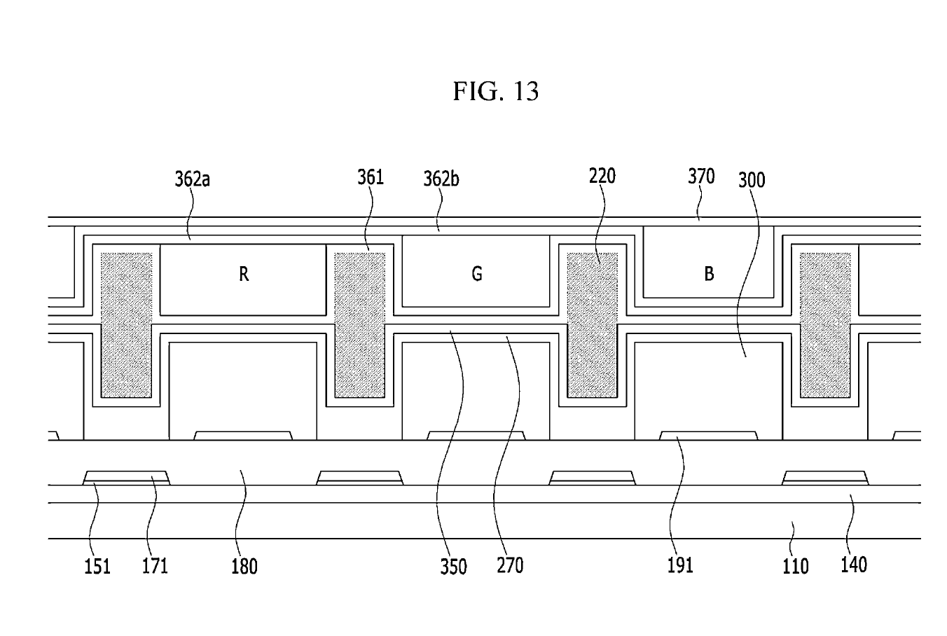

Referring to FIG. 13, the third color filter B is formed between the projected portions of the light blocking member 220 disposed in association with a third sacrificial pattern SP3. The third sacrificial pattern SP3 is disposed adjacent to the second sacrificial pattern SP2. The third color filter B is formed on the first blocking layer 362a and the second blocking layer 362b, as well as formed on the third sacrificial pattern SP3. Thereafter, the upper insulating layer 370 is formed on the second blocking layer 362b to cover the third color filter B, the second color filter G, and the first color filter R.

According to exemplary embodiments, formation of the first, second, and third color filters R, G, and B may be performed in an incomplete cured state at approximately 130° C. In exemplary embodiments, even though a color filter process is performed in an incomplete cured state, because the first blocking layer 362a and the second blocking layer 362b separate the respective color filters R, G, and B, it is possible to prevent the color filters R, G, and B from reacting to each other or otherwise mixing with one another. Further, it is noted that the first blocking layer 362a and the second blocking layer 362b may be formed covering all (or substantially all) of the substrate 110.

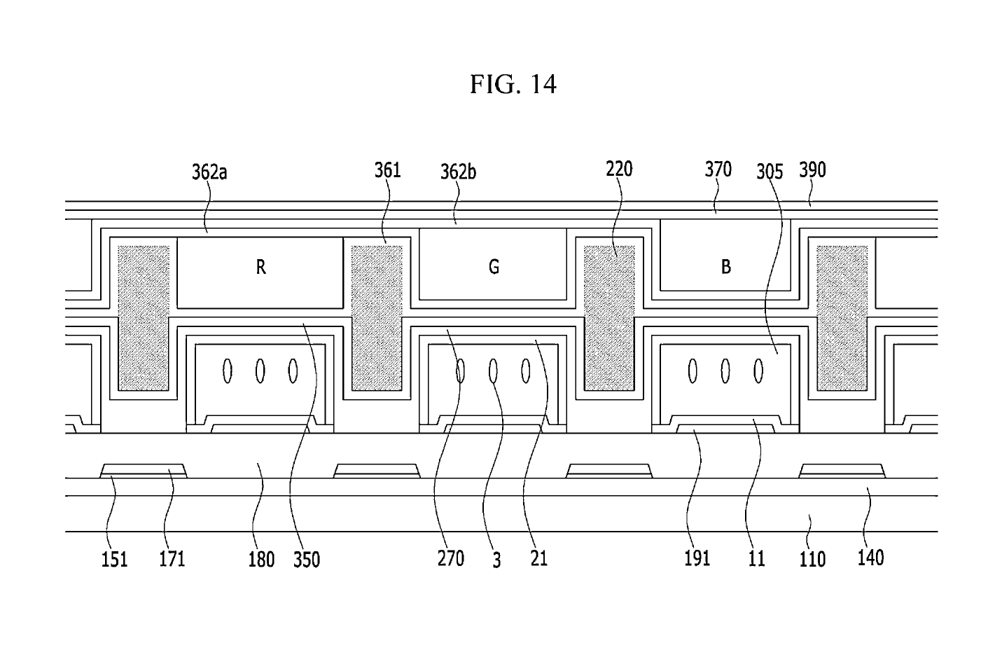

Referring to FIGS. 3 and 14, the sacrificial layer 300 is removed by, for instance, an ashing (e.g., an oxygen (O₂) ashing) process or a wet etching process through the liquid crystal injection hole 307. In this manner, the microcavities 305 may be formed. In other words, the microcavities 305 are empty spaces existing where the patterned sacrificial layer 300 is removed. Thereafter, the alignment layers 11 and 21 are formed on the pixel electrode 191 and the common electrode 270 through the liquid crystal injection hole 307. An alignment material containing a solid and a solvent is injected through the liquid crystal injection hole 307. To this end, a baking process is performed to form the alignment layers 11 and 21.

Thereafter, a liquid crystal material containing liquid crystal molecules 3 is injected into the microcavity 305 through the liquid crystal injection hole 307 using, for instance, any suitable technique, e.g., an inkjet method, etc. The capping layer 390 is formed on the upper insulating layer 370. The capping layer 390 covers the grooves GRV and to form the liquid crystal display illustrated in FIGS. 1 to 4. To this end, the capping layer covers the liquid crystal injection hole 307 of the microcavities 305 to prevent the escape of the injected liquid crystal material from the microcavities 305.

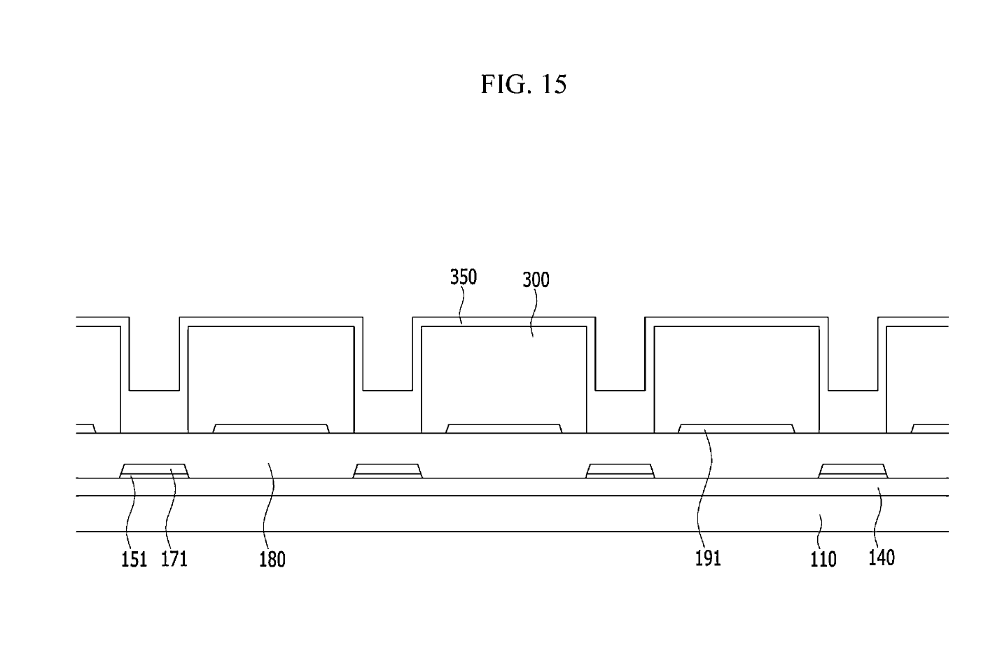

FIGS. 15 to 21 are respective cross-sectional views of the liquid crystal display of FIG. 5 at various manufacturing stages, according to exemplary embodiments. The method for manufacturing the liquid crystal display of FIG. 5 is substantially similar to the method for manufacturing the liquid crystal display of FIGS. 1-4. As such, to avoid obscuring exemplary embodiments described herein, primarily differences are provided below.

Referring to FIG. 15, the lower insulating layer 350 is formed on the patterned sacrificial layer 300 and the exposed portions of the passivation layer 180.

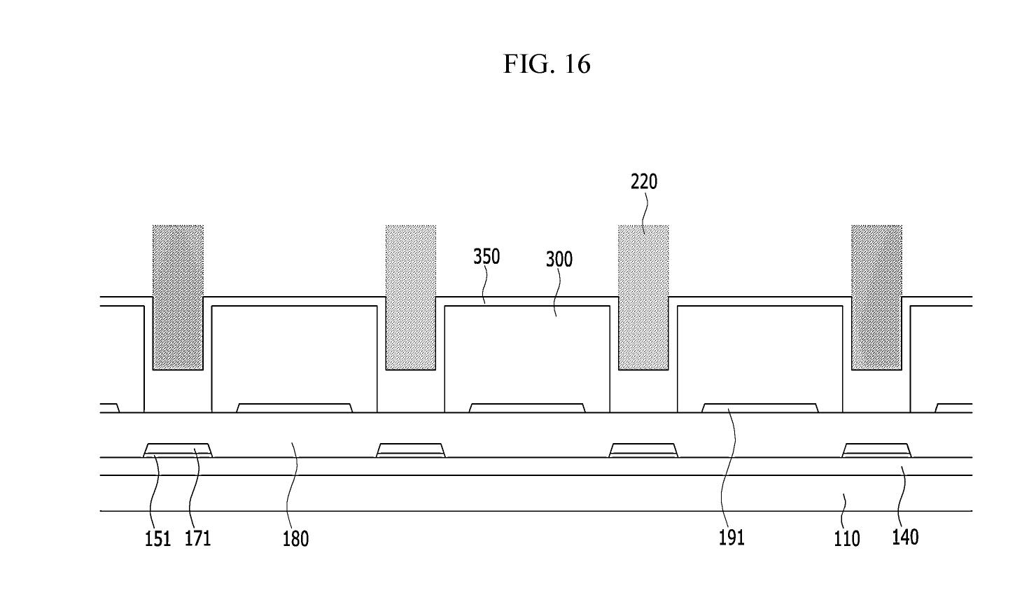

Referring to FIG. 16, the light blocking member 220 is formed between the sacrificial layers 300 that are spaced apart from each other in the first direction D1. In this manner, the light blocking member 220 may be formed including a portion that is projected upward from the lower insulating layer 350 in the third direction D3. As such, an upper surface of the light blocking member 220 may project beyond an upper surface of the lower insulating layer 350.

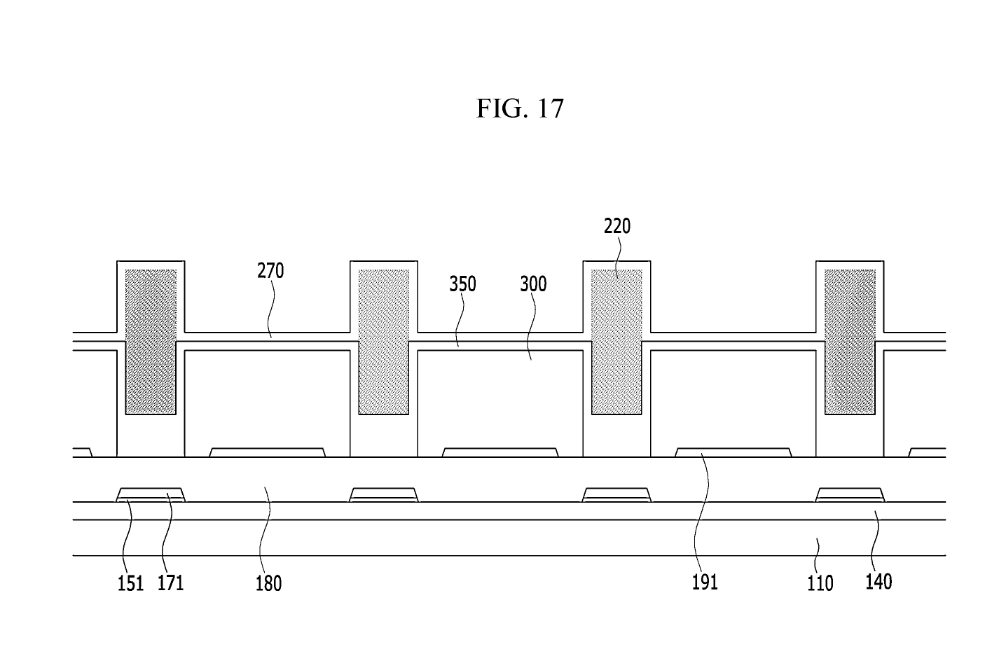

Referring to FIG. 17, the common electrode 270 is formed on the lower insulating layer 350 and covers the projected portions of the light blocking member 220. As such, unlike the as described in association with FIGS. 7-9, the light blocking member 220 is formed and then the common electrode 270 is formed to cover the projected portions of the light blocking member 220. In this manner, the light blocking member 220 may also function to reduce parasitic capacitance that may otherwise be generated between the data line 171 and a lower portion of the common electrode 270.

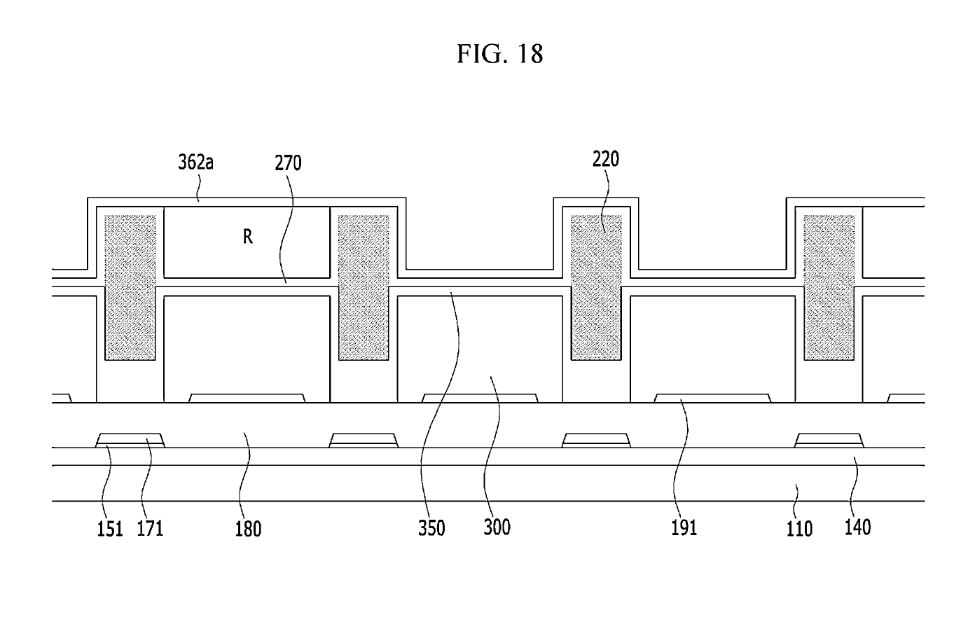

Referring to FIGS. 18 to 21, the first, second, and third color filters R, G, and B, the first blocking layer 362a, the second blocking layer 362b, the upper insulating layer 370, and the capping layer 390 are formed substantially similar to as previously described in association with FIGS. 11-14. As such, the liquid crystal display illustrated in FIG. 5 may be formed.

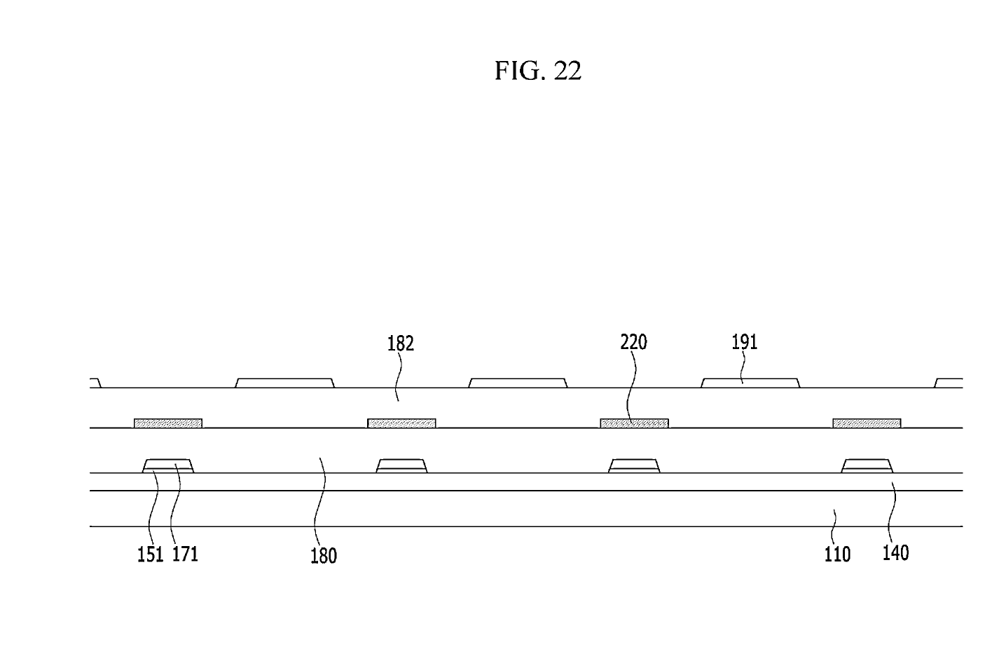

FIGS. 22 to 28 are respective cross-sectional views of the liquid crystal display of FIG. 6 at various stages of manufacture, according to exemplary embodiments. The method for manufacturing the liquid crystal display of FIG. 6 is substantially similar to the method for manufacturing the liquid crystal displays of FIGS. 1-5. As such, to avoid obscuring exemplary embodiments described herein, primarily differences are provided below.

Referring to FIG. 22, after the passivation layer 180 is formed on the substrate 110, the light blocking member 220 is formed on the passivation layer 180. In this manner, the planarizing layer 182 is formed on the light blocking member 220. The pixel electrode 191 is formed on the planarizing layer 182. In this manner, the light blocking member 220 is formed vertically between the microcavities 305 and the substrate 110.

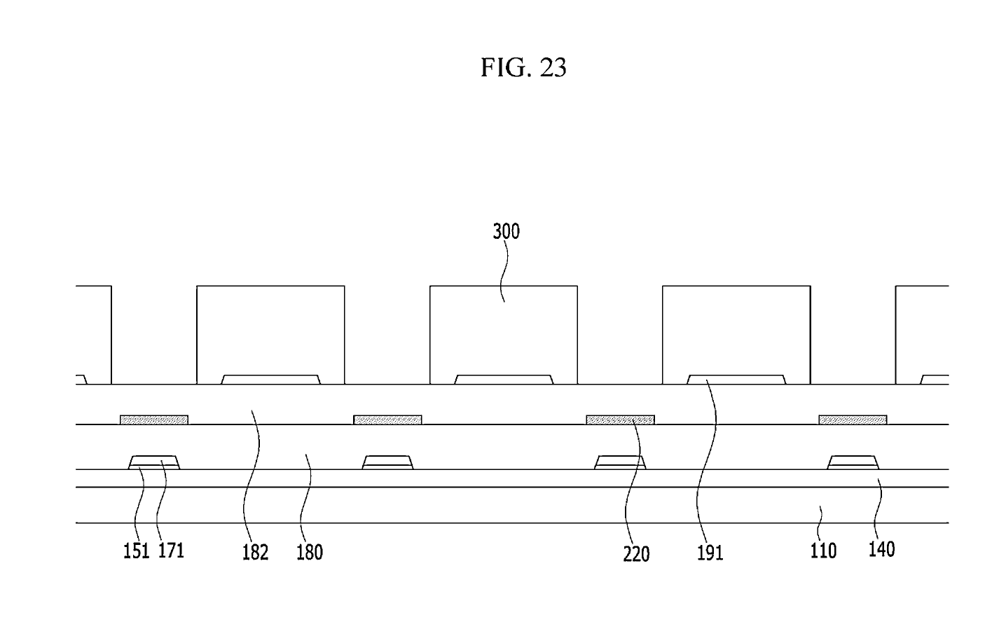

Referring to FIG. 23, the sacrificial layer 300 is formed on the pixel electrode 191 and patterned to expose portions of the planarizing layer 182. The exposed portions of the planarizing layer 182 longitudinally extend in the second direction D2. It is noted that the sacrificial layer 300 may be patterned via one or more lithographic and/or developing procedures. In this manner, the sacrificial layer 300 may be divided into portions separated from one another in the first direction D1.

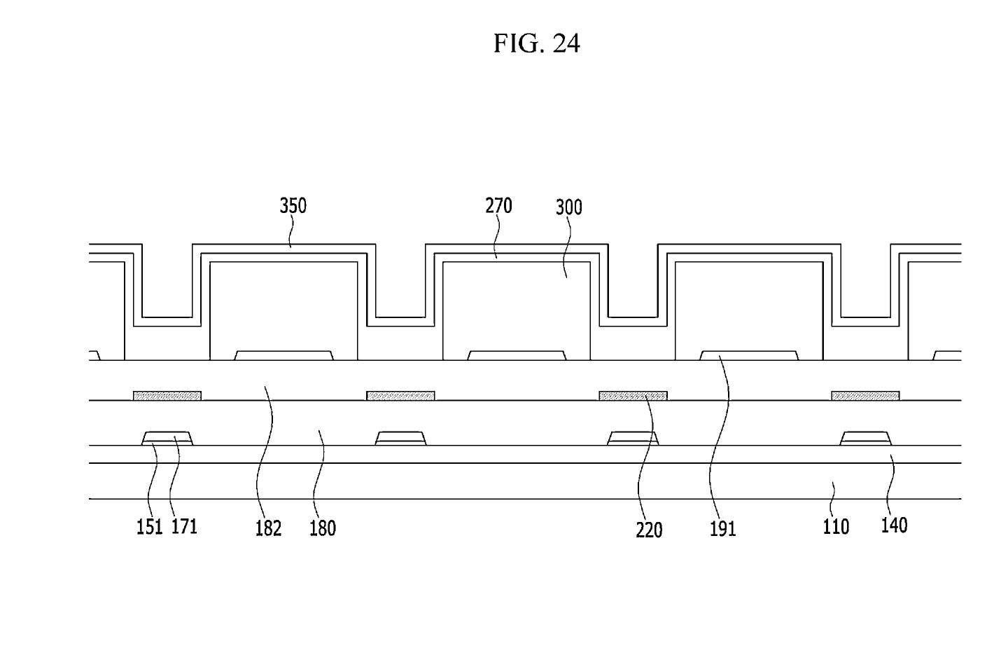

Referring to FIG. 24, the common electrode 270 and the lower insulating layer 350 are sequentially formed to cover the patterned sacrificial layer 300 and the exposed portions of the planarizing layer 182.

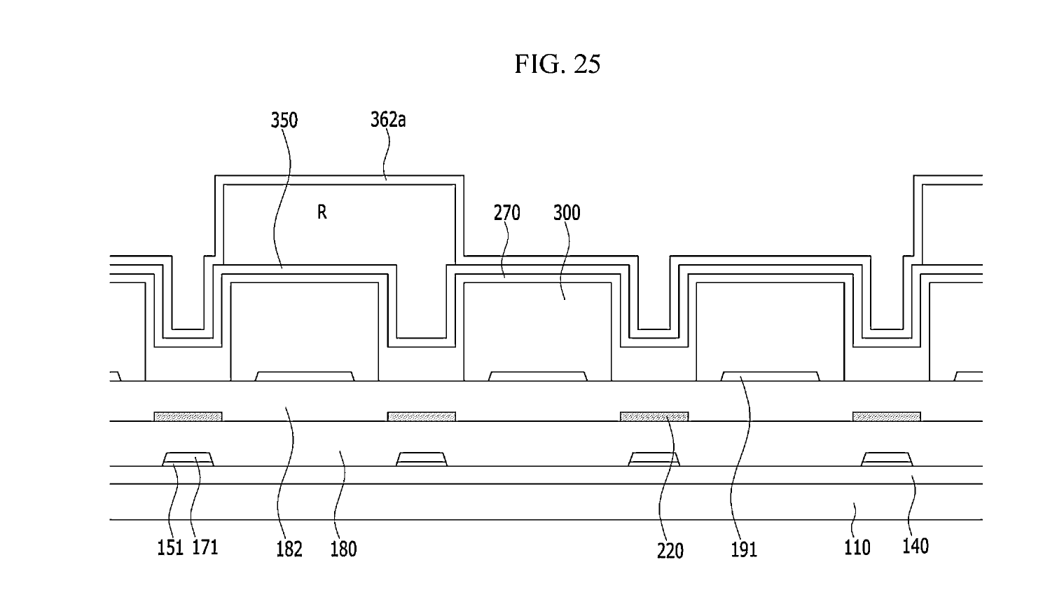

Referring to FIGS. 25 to 28, the first, second, and third color filters R, G, and B, the first blocking layer 362a, the second blocking layer 362b, the upper insulating layer 370, and the capping layer 390 may be formed substantially similar to as previously described in association with FIGS. 11-14 and 18-21. However, in FIGS. 25-38, because the light blocking member 220 is disposed below the microcavities 305, spaces disposed laterally between the plurality of microcavities 305 may be at least partially filled with respective portions of the first, second, and third color filters R, G, and B. As such, the liquid crystal display illustrated in FIG. 6 may be formed.

Although certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A display device, comprising:
a substrate;
a pixel electrode disposed on the substrate;
a roof layer facing the pixel electrode and comprising a color filter; and
a microcavity disposed between the pixel electrode and the roof layer, the microcavity comprising a controllable material disposed therein,
wherein the color filter comprises a first color filter and a second color filter,
wherein a first blocking region is disposed on the first color filter and a second blocking region is disposed on the second color filter, and
wherein the respective thicknesses of the first blocking region and the second blocking region are different.

2. The display device of claim 1, wherein the first blocking region comprises a first blocking layer disposed on the first color filter and a second blocking layer disposed on the first blocking layer.

3. The display device of claim 2, wherein:
the second blocking region comprises the second blocking layer; and
the first blocking layer is disposed between the second color filter and the substrate.

4. The display device of claim 3, wherein:
the color filter further comprises a third color filter; and
each of the first blocking layer and the second blocking layer is disposed between the third color filter and the substrate.

5. The display device of claim 4, wherein the first blocking layer and the second blocking layer comprise a transparent inorganic material.

6. The display device of claim 5, wherein:
the microcavity comprises at least two regions corresponding to pixels of the display device;
a light blocking member is disposed between the at least two regions; and
the light blocking member is projected upward to form a partition between the first color filter and the second color filter.

7. The display device of claim 6, further comprising:
a common electrode disposed on the projected portion of the light blocking member.

8. The display device of claim 5, wherein:
the microcavity is one of a plurality of microcavities;
each of the plurality of microcavities corresponds to at least one pixel of the display device; and
the color filter is disposed between adjacent microcavities.

9. The display device of claim 8, further comprising:
a thin film transistor and a light blocking member disposed the substrate,
wherein the light blocking member is disposed between the thin film transistor and the pixel electrode.

10. The display device of claim 1, wherein:
the microcavity comprises an injection hole, the microcavity being configured to receive the controllable material via the injection hole;
the display device further comprises a capping layer;
the capping layer covers the first color filter and the second color filter; and
the capping layer seals the injection hole to prevent the controllable material from escaping the microcavity.

11. A method for manufacturing a display device, comprising:
forming a pixel electrode on a substrate;
forming a patterned sacrificial layer on the pixel electrode;
forming a roof layer comprising a color filter on the patterned sacrificial layer;
removing the patterned sacrificial layer to form at least one microcavity between the roof layer and the pixel electrode; and
disposing a controllable material in the at least one microcavity,
wherein the forming the roof layer comprises:
forming a first color filter on a first portion of the patterned sacrificial layer,
forming a first blocking layer on the patterned sacrificial layer to cover the first color filter,
forming a second color filter on a second portion of the patterned sacrificial layer, and
forming a second blocking layer on the patterned sacrificial layer to cover the first color filter and the second color filter,
wherein a first blocking region is formed on the first color filter and a second blocking region is formed on the second color filter, and
wherein the respective thicknesses of the first blocking region and the second blocking region are different.

12. The method for manufacturing a display device of claim 11, wherein the first blocking region comprises the first blocking layer and a second blocking layer disposed on the first blocking layer.

13. The method for manufacturing a display device of claim 11, wherein the second blocking region comprises the second blocking layer and the first blocking layer is disposed below the second color filter.

14. The method for manufacturing a liquid crystal display claim 12, wherein:
forming the roof layer further comprises forming a third color filter; and
the first blocking layer and the second blocking layer are formed below the third color filter.

15. The method for manufacturing a display device of claim 14, wherein the first blocking layer and the second blocking layer comprise a transparent inorganic material.

16. The method for manufacturing a display device of claim 15, further comprising:
forming a light blocking member disposed between at least two regions,
wherein the microcavity comprises the at least two regions corresponding to pixels of the display device, and
wherein the light blocking member is projected upward to form a partition between the first color filter and the second color filter.

17. The method for manufacturing a display device of claim 16, further comprising:
forming a common electrode disposed on the projected portion of the light blocking member.

18. The method for manufacturing a display device of claim 15, wherein:
the microcavity is one of a plurality of microcavities;
each of the plurality of microcavities corresponds to at least one pixel of the display device; and
the color filter is disposed between adjacent microcavities.

19. The method for manufacturing a display device of claim 11, wherein the sacrificial layer is removed via wet etching the patterned sacrificial layer.

20. The method for manufacturing a display device of claim 11, wherein the controllable material is disposed in the at least one microcavity via at least one injection hole, the method further comprising:
forming a capping layer on the roof layer to cover the at least one injection hole.
